(19) United States
(12) Patent Application Publication
(10) Pub. No.: US 2009/0139485 A1
(43) Pub. Date: Jun. 4, 2009

(54) Direct injection two-stroke engine

(75) Inventor: Michael Pontoppidan, Colombes (FR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Magneti Marelli Motopropulsion France SAS, Nanterre (FR)

(21) Appl. No.: 10/584,987

(22) PCT Filed: Dec. 28, 2004
(86) PCT No.: PCT/FR2004/003400

§ 371 Date: Jun. 29, 2006

(30) Foreign Application Priority Data
Dec. 31, 2003 (FR) 0315612

(51) Int. Cl. F02B 5/00

(52) U.S. Cl. 123/305; 123/65 R

(57) ABSTRACT

A two-stroke engine having a combustion chamber (12), a cylinder (6) having an exhaust port (9) on which is centered a first diametral plane of the cylinder, a piston (4), a cylinder head (10) fitted with a sparkplug (11) on the same side as the exhaust port relative to a second diametral plane (P2-P2) perpendicular to the first, and an injector (20) adapted to spray a jet of fuel into the combustion chamber, which is on the other side of the second diametral plane, the jet injection axis (P) being at an angle α from 30° to 70° to a transverse plane (T-T) of the cylinder and an angle β from +45° to −45° to the first diametral plane. The diffuser angle γ of the jet is from 15° to 75°, injection of fuel begins when the crankshaft (3) is from 45° to 20° ahead of closure of the exhaust port (9), and the injection pressure and the orientation of the jet injection axis are determined as a function of the flow of the gases to obtain a stoichiometric air/fuel mixture in the region of the sparkplug at the moment of ignition.

The present invention relates to a two-stroke engine using direct injection of liquid fuel.

The invention relates more particularly to a direct-injection two-stroke engine having a combustion chamber delimited by:
a cylinder having a longitudinal axis, at least one inlet port and at least one exhaust port;
a piston having a substantially flat crown and moved along the longitudinal axis by a connecting rod connected to a crankshaft; and
a cylinder head provided with a sparkplug and an injector adapted to spray a jet of liquid fuel under pressure into the combustion chamber along a jet injection axis;
wherein the combustion chamber has a first diametral plane containing the longitudinal axis of the cylinder and centered on the exhaust port and a second diametral plane perpendicular to said first diametral plane, the sparkplug is in a first portion of the cylinder head extending from the second diametral plane towards the inlet port, the injector is in a second portion of the cylinder head complementary to the first portion, and the jet injection axis is at a first angle α from 30° to 70° to a transverse plane of the cylinder and a second angle β from +45° to −45° to the first diametral plane.

For each rotation of the crankshaft, the operating cycle of two-stroke engines comprises an intake/compression stroke followed by a combustion/exhaust stroke.

During the intake/compression stroke the piston moves in translation from a bottom dead centre position to a top dead centre position, successively closing the intake and exhaust ports of the cylinder. Cool gases compressed in the crankcase are then admitted via a transfer channel into the combustion chamber through the intake ports, until these ports are closed by the piston. The cool gases admitted into the combustion chamber are then compressed until the piston reaches the top dead-centre position at the same time as cool gases are aspirated into the crankcase.

During the combustion/exhaust stroke, the piston moves in translation from the top dead centre position to the bottom dead centre position, successively uncovering the exhaust and intake ports. Ignition is brought about by the sparkplug when the piston is approximately at its top dead centre position. It ignites the gas mixture and the piston is pushed back towards the bottom dead centre position by the pressure in the combustion chamber. As the piston moved towards the bottom dead centre position, the cooled gases in the crankcase are compressed and the burnt gases in the combustion chamber escape via the exhaust port once the said port is uncovered by the piston.

That type of engine has the advantage of relatively high power compared to a four-stroke engine of similar weight because there is a drive period for each rotation of the crankshaft. What is more, its manufacturing cost is particularly low because it has fewer components than a four-stroke engine.

However, compared to a four-stroke engine, that type of engine generally has the drawbacks of high fuel consumption and high emission of pollutants, because of the concomitant intake and compression phases and the exhaust phase. When the cool gases are scavenging the combustion chamber, gases charged with fuel can pass out of the exhaust port.

To alleviate those drawbacks it is possible to inject fuel directly into the combustion chamber, for example as described in patent application WO-A-02/086310.

Attempts have been made to improve the injection of fuel in some direct-injection two-stroke engines by assisting injection by injecting compressed air. However, that reduces the momentum of the injected jet and increases the complexity and manufacturing cost of the injection system.

With the aim of reducing fuel consumption, some direct injection two-stroke engines have been designed to work with a lean gas mixture by stratifying the richness of the mixture. However, that has had to be achieved by major modification of the shape of the piston and the cylinder head, and that type of solution is therefore more difficult to apply to two-stroke engines already in mass production. Moreover, a lean mixture encourages the production of certain pollutants, for example NOx, which means that applicable antipollution standards cannot be complied with unless a complex depollution system is used.

An object of the present invention is to improve direct injection two-stroke engines, in particular so that they comply with applicable and future antipollution standards, with minimum modification of the geometry of the combustion chamber, so that the invention may be applied to existing engines.

To this end, the present invention consists in an engine of the above-specified type,
characterized in that the diffuser angle γ of the jet of fuel is from 15° to 75°,
in that injection of fuel begins when the crankshaft is at an angular position from 45° to 20° ahead of the angular position of closure of the exhaust port, and
in that the fuel injection pressure and the orientation of the jet injection axis are determined as a function of the flow of the gases in the combustion chamber to obtain a substantially stoichiometric air/fuel mixture in the region of the sparkplug at the moment of ignition.

Limiting the diffuser angle γ of the jet means that the fuel droplets are formed in a limited region of the combustion chamber in which the gases have a particular speed profile and more importantly prevents spraying droplets onto the walls of the combustion chamber, which would increase the emission of pollutants.

Commencing the injection of fuel at least 20° prior to closure of the exhaust ports, in other words in advance compared to prior art direct injection systems, in which injection generally begins when the exhaust port is closed, to prevent droplets of fuel passing into the exhaust, increases the time for the fuel droplets to mix with the cool gases and for the fuel to evaporate, so that a more homogeneous air/fuel mixture is obtained at the moment of ignition.

Orienting the injection axis according to the above values of the first angle α and the second angle β reduces the passage of fuel through the exhaust port during the compression phase, despite the precocious injection of fuel.

Finally, by adapting the fuel injection pressure and by adapting the orientation of the fuel injection axis in the indicated angular ranges, it is possible to obtain a stoichiometric air/fuel mixture in the region of the sparkplug at the moment of ignition. This adaptation must be effected as a function of the flow of gases in the combustion chamber, which can be determined by numerical simulation. Given the profile of the flow lines of the gases in the combustion chamber, which is substantially constant during the ignition/compression phase, it is possible to adapt the orientation of the jet injection axis so that the droplets of fuel sprayed by the injector encounter a counterflow of gases.

Moreover, by adapting the fuel injection pressure, the momentum of the injected fuel can be modified so that the momentum of the cooled gases circulating in substantially the opposite direction stops or even pushes back the fuel droplets and vapor to obtain a stoichiometric mixture in the vicinity of the sparkplug at the moment of ignition.

Tests carried out using all the above features have indicated a very significant reduction in emission of pollutants, with the result that two-stroke engines produced in this way comply with the antipollution standards currently in force, as well as future standards that are already known at this time, without necessitating any complex and costly depollution system.

What is more, a very great reduction in fuel consumption has also been noted, of the order of 30% compared to an identical engine supplied with fuel by a carburetor, which is much greater than the expected reduction in fuel consumption, given that it is not a question of a stratified charge engine operating with a lean mixture.

Note that the above features can be applied to most existing two-stroke engines supplied with fuel by a carburetor, since all that is required to implement them is to bore a hole for the injector in the cylinder head, the geometries of the piston, cylinder and cylinder head being unmodified.

Preferred embodiments of the invention have one or more of the following features:
in order to achieve an optimum reduction of emission of pollutants over the entire operating range of the engine, the fuel injection pressure is variable as a function of the engine speed and/or the engine load;
the fuel injection pressure is from 50 bars to 150 bars;
the fuel injection pressure is adjusted to different values according to an engine speed/load map;
to reduce the emission of pollutants with a relatively simple injection system, the fuel injection pressure is constant over the whole of the range of operation of the engine, which preferably has a cubic capacity at most equal to 125 cubic centimeters (cc);
the injector is disposed in a bore of the cylinder head oriented along a given axis and the jet injection axis is at a non-zero angle δ to said bore axis;
the injector passes through the cylinder head in the first diametral plane, enabling it to be fitted to a small cubic capacity engine;
injection of fuel begins when the crankshaft is situated in an angular position from 40° to 30° ahead of the angular position of closure of the exhaust port.

Other features and advantages of the invention will become apparent in the course of the following description, which is given by way of non-limiting example and with reference to the appended drawings, in which:

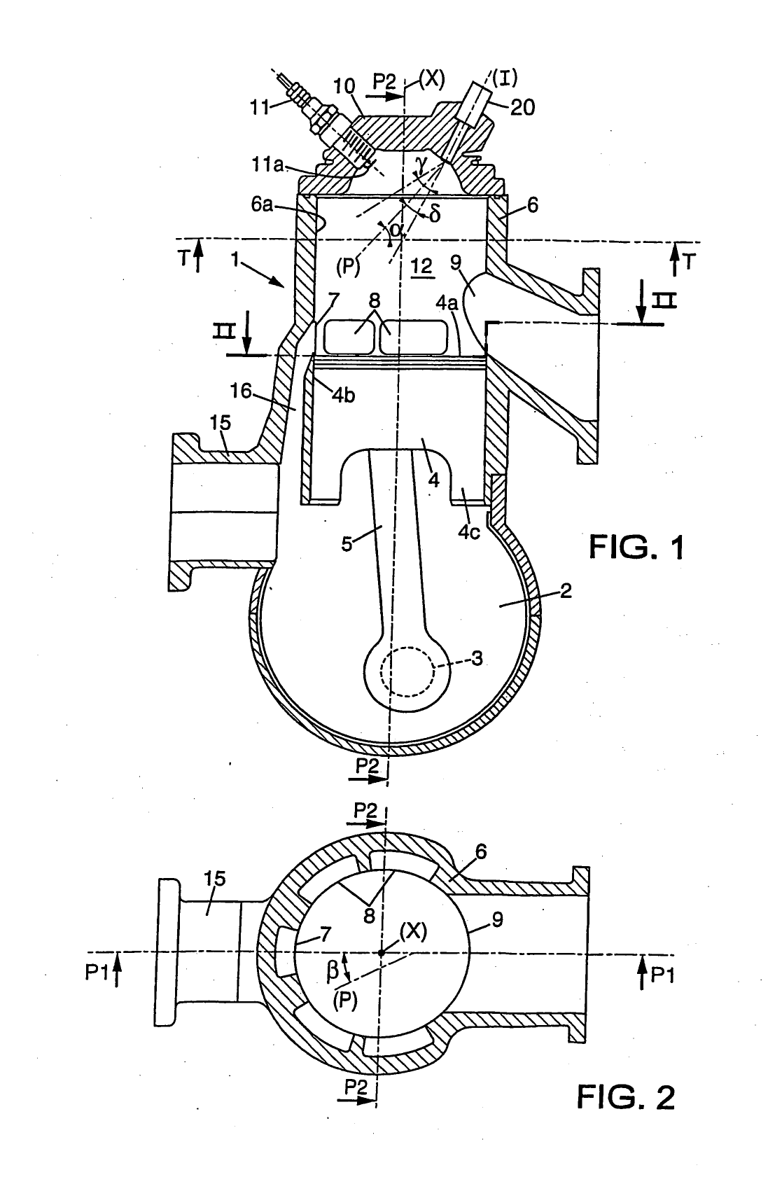

FIG. 1 is a simplified view in section on a diametral plane of the cylinder of a direct-injection two-stroke engine conforming to the invention;

FIG. 2 is a simplified view in section taken along the line II-II in FIG. 1;

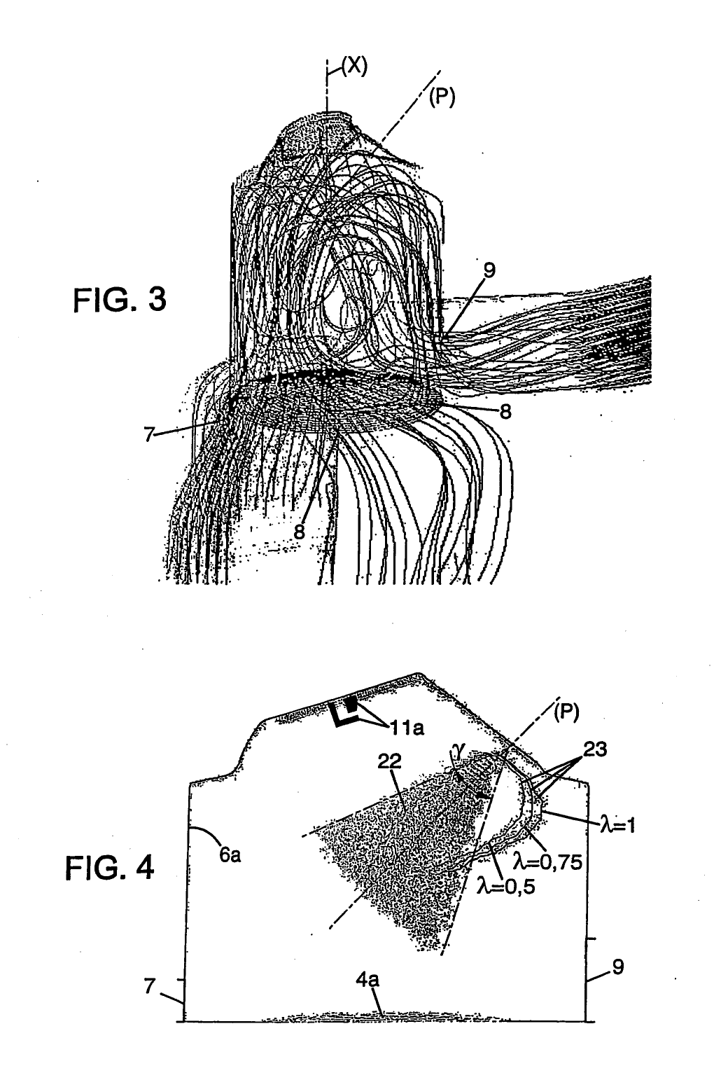

FIG. 3 is a diagram obtained by numerical simulation representing gas flow lines in a two-stroke engine; and

FIGS. 4 to 6 represent the propagation of the jet of fuel and the changes to the region in which a substantially stoichiometric mixture is obtained in an engine conforming to the invention between the start of injection and the moment of ignition.

The same reference numbers are used in the various figures to designate identical or similar components.

FIG. 1 shows in section a single-cylinder two-stroke engine fitted with a direct injection system.

Apart from the injection system, the structure of this engine is known in the art and in all respects similar to the structure of existing mass-produced two-stroke engines with a carburetor.

The engine structure includes a crankcase 2 inside which a crankshaft 3 is rotatably mounted. The crankshaft 3 is connected to a piston 4 by a connecting rod 5. The piston 4 has a crown 4a, a head 4b fitted with sealing rings, and a skirt 4c. The crown 4a of the piston can be flat, as in the embodiment shown here, or slightly domed. Note that this piston is of completely standard shape, and is not a piston having significant raised patterns or cavities on its crown, as in certain experimental two-stroke engines designed to work with a lean mixture.

The piston 4 is mobile in a cylinder 6 along the longitudinal axis X of the cylinder.

The wall 6a of the cylinder is provided with intake ports 7, 8 and an exhaust port 9. To be more precise, the intake ports comprise a main port 7 facing the exhaust port 9 and four supplementary intake ports 8, known as scavenging ports, disposed on respective opposite sides of the main intake port. However, the intake and exhaust ports could have other configurations known in the art, for example a single intake port, scavenging ports 8 disposed asymmetrically relative to the main port 7, or multiple exhaust ports 9.

The end of the cylinder 6 opposite the piston 4 is closed by a cylinder head 10 which is substantially hemispherical in this embodiment and is fitted in the manner known in the art with a sparkplug 11.

The crown 4a of the piston, the inside wall 6a of the cylinder, and the inside face of the cylinder head 10 delimit a combustion chamber 12 of the engine.

Cool gases are admitted into the crankcase 2 via an intake pipe 15, in particular because of the reduced pressure created in the crankcase when the piston 4 rises towards the cylinder head 10, i.e. during the intake/compression period. When the piston 4 descends towards the crankshaft 3 during the combustion/exhaust phase, the cool gases in the crankcase 2 are transferred via a transfer channel 16 to the intake ports 7, 8. The intake pipe 15 may be equipped with check valves and/or be masked by the flanges of the crankshaft to prevent cooled gas flowing back through the intake pipe during the combustion/exhaust stroke. This is known in the art.

The intake ports 7, 8 are situated at a greater longitudinal distance from the cylinder head 10 than the exhaust port 9 and are therefore closed by the piston 4 before the exhaust port 9 during the intake/compression phase.

During the intake/compression phase, the exhaust port 9 is closed by the piston 4 from a certain angular position of the crankshaft, which is called the exhaust port closure angular position or the exhaust closure angle. This angular position is defined accurately by the structure of the engine.

Two-stroke engines having the above kind of structure are well-known in the art and can be mass produced at a particularly competitive price. Their cubic capacity varies greatly as a function of their use. For example, to power a portable tool such as a chainsaw or strimmer, the cubic capacity is generally from around 15 cc to around 40 cc, whereas to power a two-wheel vehicle of the moped, motorcycle, or leisure vehicle kind, the cubic capacity generally varies from 50 cc to 400 cc. The total cubic capacity of the engine may be even greater in the case of a multicylinder engine.

A first diametral plane of the combustion chamber contains the longitudinal axis X of the cylinder and is centered on the exhaust port 9. If the cylinder 6 has more than one exhaust port, the first diametral plane must be centered on an imaginary port having a geometrical area equivalent to the sum of the areas of all the exhaust ports. This first diametral plane corresponds to the section plane used in FIG. 1 and its position (P1-P1) can be seen in FIG. 2.

A second diametral plane is perpendicular to the first diametral plane (P1-P1) and its position (P2-P2) can be seen in FIGS. 1 and 2.

The second diametral plane (P2-P2) delimits a first portion of the inside face of the cylinder head 10, including the second diametral plane, which extends towards the main intake port 7.

The sparkplug 11 is located in this first portion of the cylinder head, i.e. the sparkplug well opens into this region, either at an angle to the longitudinal axis X, as in the embodiment shown here, or aligned with or coinciding with the longitudinal axis X.

The engine 1 is equipped with an injection system comprising an injector 20 adapted to spray liquid fuel under pressure into the combustion chamber 12 along a jet injection axis P.

The injector 20 is disposed in a second portion of the cylinder head complementary to the first portion of the cylinder head, i.e. the injection end of the injector 20 discharges onto the second portion of the inside face of the cylinder head.

To be more precise, and as is clear in FIGS. 1 and 2, the injector 20 is disposed in the cylinder head in the first diametral plane (P1-P1) centered on the exhaust port, to enable it to be fitted to an engine of low cubic capacity.

The jet injection axis P defined by the axis of symmetry of the jet of fuel produced by the injector defines a first angle α to a transverse plane (T-T) of the cylinder, i.e. perpendicular to the longitudinal axis X. The precise manner of determining this first angle α as a function of the geometry of the combustion chamber is explained below, but for most two-stroke engines this angle has to be from 30° to 70°.

The jet injection axis P also defines a second angle β to the first diametral plane (P1-P1) centered on the exhaust port 9. This angle, which is visible in FIG. 2, must be from +45° to −45° and the precise manner of determining it is explained below. The jet injection axis P with first and second angles α, β within these ranges of values is directed towards the half of the cylinder opposite the exhaust port.

In this embodiment the jet of fuel is of conical shape, exhibiting circular symmetry about the axis P, but it is possible to use a jet of fuel of more complex shape, for example a jet having an oval cross-section. However, the diffuser angle γ of the jet of fuel that is defined by the two opposite edges of the jet of droplets must be from 15° to 75° so that it can be directed towards a relatively localized region of the combustion chamber and more importantly so that the droplets do not impinge directly on the walls of the combustion chamber, which would have a highly unfavorable effect on the emission of pollutants.

The injection system naturally has a control system, not shown, for controlling the time at which injection begins and its duration. The control system is connected to means for determining the angular position of the crankshaft, to send a signal to open the injector 20 at the appropriate time, and to means for determining operating parameters of the engine, for example an engine speed sensor and/or an engine load sensor, to determine the duration of injection and consequently the quantity of fuel injected.

The control system operates on the injector 20 so that, for some ranges of operation at least, the injection of fuel begins when the crankshaft is in an angular position from 45° to 20° prior to the exhaust port closure position, and preferably in an angular position from 40° to 30° prior to the exhaust closure angle. This injection is precocious in the sense that it begins when exhaust gases are still being evacuated towards the exhaust port. In particular it is more precocious than in most prior art direct-injection systems, which seek to delay the beginning of injection to prevent a portion of the mixture of gas and unburnt fuel passing through the exhaust port.

However, passage of unburnt gas through the exhaust port is prevented by adapting the fuel injection pressure and adapting the orientation of the jet injection axis P in the angular ranges indicated above and in the manner explained below.

Advance injection means that a greater quantity of fuel is injected during the cycle and is therefore particularly advantageous when the engine is operating at full load and at high speed. However, the invention does not exclude the possibility of beginning injection later, after closure of the exhaust port, for some ranges of operation of the engine.

To adapt the fuel injection pressure and the orientation of the jet injection axis P correctly, they must be determined as a function of the flow of the gases in the combustion chamber to obtain a stoichiometric gas mixture in the region of the sparkplug 11 at the moment of ignition. Ignition is caused by a spark passing between the electrodes 11a of the sparkplug in the usual way when the crankshaft is in an angular position a few degrees before the top dead centre position of the piston, this ignition advance being greater or smaller as a function of the engine rotation speed or load.

The injection pressure and the orientation of the jet injection axis P are preferably determined by numerical simulation of the flow of gases in the combustion chamber during the intake/compression phase. Numerical simulation determines the precise path of the streams of gas in the combustion chamber, as shown in FIG. 3, which represents the gas flow lines when the piston is still at a relatively low position. Note, however, that because of the high kinetic energy of the gases entering the combustion chamber, the shape of these flow lines does not change significantly at any time in the intake/compression phase.

As may be seen in FIG. 3, the gases essentially perform a tumbling movement, i.e. a movement of rotation about an axis parallel to the crankshaft axis. This is caused by the diametrally opposite positions of the main intake port 7 and the exhaust port 9 and the symmetrical disposition of the scavenging ports 8 on either side of the main intake port. However, with ports that are not symmetrically disposed relative to the first diametral plane (P1-P1), a swirl component of movement is introduced, i.e. a partial movement of rotation about the longitudinal axis X of the cylinder.

The angle α of the jet injection axis P is adjusted in the range from 30° to 70° so that the jet of fuel is sprayed into a counterflow stream of cooled gas coming from the intake ports 7, 8. Note that the base of the jet of fuel passes through the streams of gas in the immediate vicinity of the outlet of the injector 20 on the inside face of the cylinder head 10. However, because of the compromise between the diffuser angle γ and the injection pressure (the momentum of the jet), the particles of fuel in the vicinity of the cylinder head are not yet finely atomized and their kinetic energy is high, and so the gas streams in the vicinity of the injector 20 have little effect on the propagation of the jet in the combustion chamber 12.

In this embodiment there is no swirl phenomenon about the X axis of the combustion chamber and the second angle β of the jet injection axis P must therefore be substantially zero. In contrast, in the presence of a swirling movement, the angle β must be greater or smaller as a function of the amount of such swirling movement, so that the propagation of the jet is as close as possible to counterflow propagation with respect to the streams of cool gas. The positive or negative sign of the second angle β is determined as a function of the direction of rotation of the swirling movement of the gases, of course.

Moreover, the injection pressure must also be adapted as a function of the flow of gases in the combustion chamber. To prevent spraying droplets of fuel directly on the wall 6a of the cylinder or onto the crown 4a of the piston the injection pressure must not be too high. However, the injection pressure must be sufficiently high for the fuel droplets to reach a region in which they encounter counterflow gas streams and not to be entrained towards the exhaust port 9 by streams of gas flowing along the wall of the cylinder head 10.

The appropriate injection pressure can be determined from a gas speed diagram, also obtained by numerical simulation. This diagram, not shown, consists of vectors oriented along the flow lines and of greater or lesser length as a function of the speed of the gases at the point concerned. Once the orientation of the jet injection axis P has been determined, it is possible to determine the injection pressure such that the momentum of the droplets of fuel in the region of diffusion of the jet is substantially equal to, less than or slightly greater than the momentum of the counterflowing gases, according to the required mixture profile.

Although the inventor has used numerical simulation to adapt the jet injection axis P and the injection pressure, determining values of these parameters in the ranges indicated by means of tests and the empirical knowledge of the person skilled in the art as to the flow of the gases as a function of the geometry of the combustion chamber may be envisaged. However, it is important for injection to begin precociously, i.e. from 45° to 20° before, and preferably from 40° to 30° before, the exhaust closure angle.

The propagation of the jet of fuel and the changes to the region in which the air/fuel mixture is substantially stoichiometric during the compression phase shown in FIGS. 4 to 6 are achieved by adapting the jet injection axis P and the injection pressure accordingly. Here the term “air” refers not only to the cool gases aspirated during the intake phase but also to any residue of gases burnt during the preceding cycle or of exhaust gases returned to the combustion chamber by an EGR system.

FIG. 4 shows the propagation of the jet of fuel just after injection commences 40° ahead of the exhaust closure angle for this embodiment. The jet has a frustoconical shape which exhibits symmetry of revolution about the axis P. The diffuser angle γ of the jet is approximately 50°.

The curves 23 indicate the contour of the regions of the combustion chamber in which there are various values of λ (Lambda), λ being defined as the ratio between the proportions of air and fuel actually present and the theoretical proportions of air and fuel necessary to obtain a stoichiometric mixture. A mixture of air and fuel is stoichiometric when the C—H chains are totally oxidized. Thus the air/fuel mixture is stoichiometric in a region of the combustion chamber in which a value of λ equal to 1 is found.

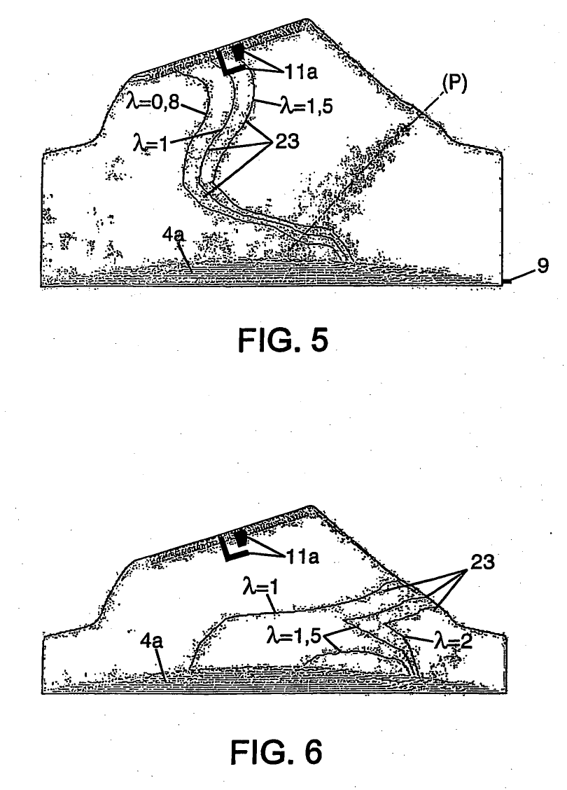

Note that although the region defined by the contours 23 is slightly offset toward the exhaust port relative to the jet injection axis P, this portion of the mixture is not entrained as far as the exhaust port 9. In fact, the large momentum of the injected fuel entrains it towards the half of the cylinder situated on the same side as the inlet ports 7, 8, as may be seen in FIG. 5.

The situation represented in FIG. 5 corresponds more or less to the moment at which the exhaust port is closed, i.e. to a situation approximately 40° after the FIG. 4 situation. In this case, the momentum of the fuel is cancelled out by the momentum of the cool gases, which continue to move even though the intake ports are closed. Note that the injection of fuel may continue after the closure of the exhaust port 9.

When the piston reaches the vicinity of the top dead centre position, the portion of the combustion chamber in which a stoichiometric mixture is present now occupies the region around the sparkplug, as may be seen in FIG. 6, in which the electrodes 11a of the sparkplug are shown symbolically. This situation is obtained as a result of the return movement of the fuel towards the injector 20 caused by the kinetic energy of the admitted gases. In this situation, the fuel is vaporized and forms a stoichiometric mixture with the cool gases.

Ignition is then commanded by producing a spark between the electrodes 11a of the sparkplug to ignite the stoichiometric mixture.

Note that the stoichiometric mixture occupies the major portion of the combustion chamber. Only a small portion of the combustion chamber at the same end as the exhaust port contains a lean mixture, which guarantees regular combustion.

The resulting direct injection considerably reduces the emission of pollutants from a two-stroke engine of existing type and in particular complies with antipollution standards.

What is more, tests carried out with two-stroke engines in accordance with the invention using direct injection have demonstrated spectacular reductions in fuel consumption. In fact, for certain engines, there has been observed a 30% reduction of fuel consumption over a regulatory antipollution cycle on changing from supplying fuel by a carburetor to supplying fuel by direct injection in accordance with the invention. This reduction, which exceeds that generally obtained with prior art direct injection systems for two-stroke engines, may in part be explained by starting injection precociously, as this increases the time for the fuel to evaporate and produces a stoichiometric mixture in a large portion of the combustion chamber.

The flow of the gases in the combustion chamber, and primarily the gas speed diagram, can vary significantly as a function of engine speed and load. In certain embodiments, and in particular in engines of relatively high cubic capacity, it may be preferable for the injection pressure to vary as a function of the engine speed and/or load. The injection pressure can be varied by the injection system in a manner that is known in the art. For example, the injection system can be connected to an engine speed sensor and a gas inlet valve opening sensor and include means for regulating the pressure in a pressurized fuel accumulator. By adjusting the injection pressure of the fuel to a value from 50 to 150 bars, optimum combustion can be obtained over the whole of the range of operation of the engine. Of course, the injection control system is also adapted to monitor the injection duration in order to inject only the necessary quantity of fuel.

The injection pressure may vary considerably over the whole of the range of operation of the engine or in accordance with different discrete values according to an engine speed/load map.

However, in engines of low cubic capacity, i.e. engines having a cubic capacity of 125 cc or less, it is possible to adopt a constant injection pressure over the whole of the range of operation of the motor at the same time as achieving a significant reduction in the emission of pollutants and in fuel consumption. Injecting fuel at a constant pressure, for example a pressure of 80 bars for a 50 cc engine, enables the use of a relatively simple injection system that does not excessively increase the cost of the engine.

Moreover, as may be seen in FIG. 1, it is possible to dispose the injector 20 in a bore in the cylinder head 10 oriented along an axis I that is not colinear with the jet injection axis P, i.e. is at a non-zero angle δ to the jet injection axis P. This offers greater flexibility in placing the injector 20 in the cylinder head 10 to spray fuel along a particular axis P. This may be particularly advantageous when seeking to fit the injection system to an existing two-stroke engine whose cylinder head geometry limits the options for forming the bore for the injector 20.

Although the embodiments shown in the various figures correspond to a two-stroke engine having a main intake port, four scavenging ports and an exhaust port disposed symmetrically with respect to the first diametral plane (P1-P1), it will be clear to the person skilled in the art that the injection system of the invention may be adapted to a two-stroke engine having a different number of ports or having its ports disposed asymmetrically and to a multicylinder two-stroke engine.

1-8. (canceled)

9. A direct-injection two-stroke engine having a cubic capacity of 125 cc at most and a combustion chamber delimited by:
a cylinder having a longitudinal axis, at least one inlet port and at least one exhaust port a piston having a substantially flat crown and moved along the longitudinal axis by a connecting rod connected to a crankshaft; and
a cylinder head provided with a sparkplug and an injector adapted to spray a jet of liquid fuel under pressure into said combustion chamber along a jet injection axis and with a jet diffuser angle γ from 15° to 75°,
wherein said combustion chamber has a first diametral plane containing said longitudinal axis of the cylinder and centered on said exhaust port and a second diametral plane perpendicular to said first diametral plane,
said sparkplug is in a first portion of said cylinder head extending from the second diametral plane towards said inlet port,
said injector is disposed in a bore in said cylinder head oriented along a determined axis and in said first diametral plane in a second portion of the cylinder head complementary to said first portion, and
said jet injection axis is at a first angle α from 30° to 70° to a transverse plane of said cylinder and a second angle β from +45° to −45° to said first diametral plane,
wherein said jet injection axis is at an non-zero angle δ to said cylinder head bore determined axis,
wherein a control system is adapted to command the commencement of injection of fuel when said crankshaft is at an angular position from 45° to 20° ahead of the angular position of closure of said exhaust port, and
wherein the fuel injection pressure and the orientation of said jet injection axis are determined as a function of the flow of the gases in said combustion chamber to obtain a substantially stoichiometric air/fuel mixture in the region of said sparkplug at the moment of ignition.

10. An engine according to claim 9, wherein injection of fuel begins when said crankshaft is situated in an angular position from 40° to 30° ahead of the angular position of closure of said exhaust port.

11. An engine according to claim 9, wherein said fuel injection pressure is from 50 bars to 150 bars.
